(19) United States
(12) Patent Application Publication
(10) Pub. No.: US 2001/0033555 A1
(43) Pub. Date: Oct. 25, 2001

(54) System for realization of a base station controller in compact PCI

(76) Inventors: Jun Man Kim, Sungnam (KR); No Hee Park, Ichon (KR); Moon Seok Baek, Seoul (KR)

Correspondence Address: BAKER & BOTTS, 30 ROCKEFELLER PLAZA, NEW YORK, NY, 10112

(21) Appl. No.: 09/833,010

(22) Filed: Apr. 11, 2001

(30) Foreign Application Priority Data
Apr. 20, 2000 (KR) 2000-20890

(51) Int. Cl. H04Q 7/00; H04L 12/66

(52) U.S. Cl. 370/328; 370/463

(57) ABSTRACT

There is provided a system for realization of a base station controller in a compact PCI, which establishes a code division multiple access (CDMA) base station controller partly using functions of H.110. The system for realizing a base station controller in a compact PCI uses paths for CDMA packet routines by using partial functions of H.110, extracts clocks from networks without using a GPS and composes a reference clock of the base station controller using the extracted clocks to use the reference clock as a reference frequency in CDMA.

### BACKGROUND OF THE INVENTION

1. Field of the Invention

The present invention relates to a system for realizing a base station controllers in a compact PCI, and more particularly, to a system for realizing a base station controller in a compact PCI, which establishes a code division multiple access (CDMA) base station controller using a standardized compact PCI standard bus and partly using functions of H.110.

2. Description of the Related Art

Referring to FIG. 1, a conventional CDMA base station controller (BSC) 10 includes a base station manager (BSM) 20, a global positioning system (GPS) 30, a clock distributor (CKD) 40, a global communication interconnection network and local communication interconnection networks (GCIN, LCIN) 50 and 60, an alarm control processor (ACP) 70, a call control processor (CCP) 80, and a traffic signal bus (TSB) block 90. The BSM 20 that takes charge of operation of the BSC 10 and a base station transceiver subsystem (BTS) 100, management of resources, management of status, management of forms, user interface, maintenance, etc. is configured of a line space workstation and various input/output devices for user convenience. The GCIN 50 and LCIN 60 provide packet data communication interconnections among subsystems.

The GCIN 50 is connected with the LCIN 60 of each BSC to furnish communication interconnection between BSCs 10, and it is also connected to the BSM 20 and the BSC-GPS 30 which are common parts of twelve BSCs. The LCIN 60 provides communication interconnections among blocks inside the BSC and includes a trunk interface circuit for connecting the BTS remotely located therefrom. The CCP 80 is a processor system for executing a call processing control in the entire BSC, including selector management, through communication interconnection networks (CINs). The CCP 80 is connected to a mobile station controller for signal data processing.

The BSC-GPS 30 is a system for providing reference time used in CDMA systems. The clock distributor 40 converts clocks received from the BSC-GPS 30 to distribute synchronous signals requisite for the system. The ACP 70 receives a variety of alarm states in the BSC and informs them to the BSM 20, to allow the BSM to efficiently manage and operate the system. The transcoder and selector bank (TSB) 90, which is connected with a mobile station controller (MSC) 110 through a trunk (E1), performs conversion of a received 64 kps pulse-code-modulation voice signal using QCELP algorithm to transmit it to a channel unit of the base station through the LCIN 60 and carries out its reverse function. In addition, the TSB 90 executes hand off and a power control for wireless links in connection with the base station.

The BSC 10 and the MSC 110 are connected with each other via maximum thirty-two E1 lines through the transcoder and the TSB block 90 in case of transmitting a traffic signal. Here, a separate IPC link is used for the signals when the inner protocol is employed. The BSC 10 can be connected with the BTS 100 via E1 or T1 line, or a HDSL, through the LCIN 60. Traffic signals and other control and management signals in the BSC 10 are transmitted in a packet mode to the BTS 100 through the LCIN 60. All of BSCs and the MSC are located at the same place according to an establishment environment and, in this case, they use IPC signal mode. There are many restrictions for using the conventional BSC that only standard products are used for realization of functions thereof including using of the BSM as a workstation.

As described above, the conventional system becomes large-sized and its cost increases because it must contain many components that are redundantly required. Furthermore, configurations of buses mainly used in a standard compact PCI are complicated.

### SUMMARY OF THE INVENTION

It is, therefore, an object of the present invention is to provide a system for realization of a base station controller in a compact PCI standard bus, which uses part of functions of H.110 to make the entire system of the base station controller simpler and smaller.

To accomplish the object of the present invention, the system for realizing a base station controller in the compact PCI uses paths for CDMA packet routines by using partial functions of H.110, extracts clocks from networks without using a GPS and composes a reference clock of the base station controller using the extracted clocks to use the reference clock as a reference frequency in CDMA.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawing, in which like reference symbols indicate the same or the similar components, wherein:

FIG. 1 is a block diagram of a conventional base station controller;

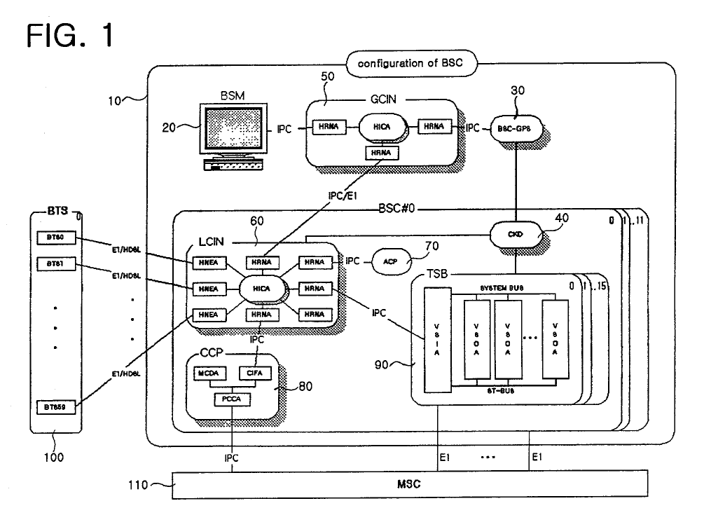

FIG. 2 illustrates an apparatus for realizing a base station controller in a compact PCI according to the present invention; and

FIG. 3 is a flow chart showing a process of compensating a reference clock of the base station controller of FIG. 2.

### DETAILED DESCRIPTION OF THE PREFERRED EMBODIMENT

Reference will now be made in detail to the preferred embodiments of the present invention, examples of which are illustrated in the accompanying drawings.

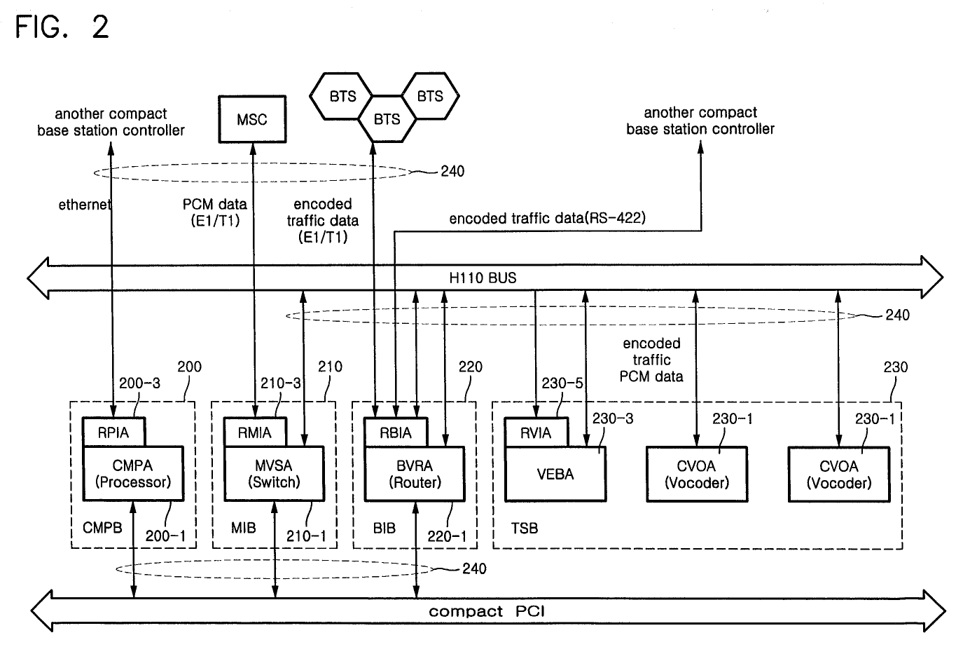

FIG. 2 is a block diagram of a system for realizing a base station controller in a compact PCI according to the present invention. The system of the invention comprises: a compact base station controller main processor block (CMPB) 200; a mobile station controller interface block (MIB) 210; a BTS interface block (BIB) 220; a transcoder and selector bank (TSB) 230; a back plane (not shown) and a system interface 240.

The CMPB 200 has a compact base station controller main processor assembly (CMPA) 200-1, and a rear processor interface assembly (RPIA) 200-3. The CMPA 200-1 serving as the main processor of a compact base station controller takes charge of management of call resources in base stations and base station controllers, operator interface, processing and managing of failures/alarms, status management, system diagnostics management, processing of base station controller calls, system form management, system loading and processing of statistics. The RPIA 200-3 supports an Ethernet port for performing operation and maintenance of one to three compact base station controllers.

The MIB 210 includes a MSC vocoder interface and a switching assembly (MVSA) 210-1 and a rear MSC interface assembly RMIA 210-3. The MVSA 210-1 manages MSC trunks connected to the mobile station controllers (MSCs) and carries out IS-634(A) interface, vocoder switching, IWF interface and generation of a reference clock, being interfaced with the CMPA 200-1 using the compact PCI. The RMIA 210-3 provides E1/T1 trunk nodes for interfacing with the MSCs.

The BIB 220 has a BSC vocoder interface and a router assembly (BVRA) 220-1 and a rear BSC interface assembly (RBIA) 220-3. The BVRA 220-1 manages BTS trunks connected to BTSs, and routes all control data transmitted to the CMPA 200-1. The BVRA 220-1 is interfaced with the CMPA 200-1 using the compact PCI and downloads data to a compact base station controller vocoder operation assembly (CVOA) 230-1. The RBIA 220-3 performs switching to provide E1/T1 fractional E1 interface, extended compact base station controller HDSL packet data interface, H.110 relay link interface, 2M(in E1/T1 fractional E1), 8M (in H.11) and fractional E1 with the BTSs.

The TSB 230 includes the CVOA 230-1, a vocoder extension buffer assembly (VEBA) 230-3 and a rear vocoder extension interface assembly (RVIA) 230-5. In case of 120ch/1shelf in pace 2, the VEBA 230-3 and the RVIA 230-1 can be removed. The CVOA 230-1 encodes and decodes voices, manages the state of display, and performs display loading if required. The VEBA 230-3 takes charge of interfacing with a main shelf. The RVIA 230-5 provides a node of interface with the main shelf.

The back plane furnishes the compact PCI, H.110 bus and I/O bus. The system interface 240 corresponds to channeled E1/T1 that is an interface between the MSCs and the compact BSCs, IS-634 (A), E1/T1 fractional E1.IPC that is an interface between the BTSs and the compact BSCs, RS 422. IPC that is a GW interface with compact BSCs, TCP/IP that is Ethernet between the compact BSCs and the base station operation system interface, a compact H110 that is an interface between a main shelf and an extension shelf, a compact PCI bus that is the interface between a main processor router and a switch, and H.110 that is the interface between a vocoder router and the switch. The compact PCI bus includes a 64-bit 32-bit) PCI bus and H.110 bus (32 streams) that is a computer telephone bus. The PCI bus is used as a system bus for communications among processors.

The H.110, the computer telephone bus, is used as paths for pulse code modulation and packet routing. The reference clock is configured by using 8 KHz extracted from E1 or T1 without using an additional GPS and clock-related blocks into 50 Hz (20 msec) which is the time standard of the reference call. The reference clock is different from 1PPS datum point of the GPS of the conventional system. To correct this difference, delays between the vocoder selector and a cell site modem of a channel card are calculated to perform a correction algorithm.

Meanwhile, a workstation function, named as the base station operating system, which takes charge of maintenance and repair in conventional DSC, PCS systems is applied to the BSC system configured of the compact PCI. A call-processing block for call processing is also applied to the BSC system. One trunk board is included in the system, which is in charge of E1/T1 interface with a switching center and provides NO7 and V5.2 signals

Multiple vocoder blocks transmit/receive voice packets to/from the base station through HDSL packet routing using the H.110 bus, and perform pulse-code-modulation communications with the switching center through the trunk board using the H.110. There is a base station interface board for managing the vocoder blocks and interfacing with the base station. This base station interface board routes voice packet data from the vocoder blocks to the base station and vice versa.

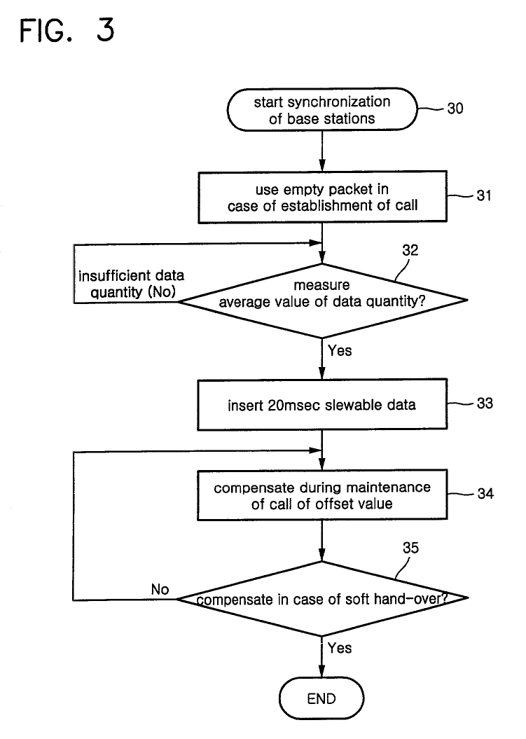

FIG. 3 is a flow chart showing a process of compensating a reference clock of the base station controller of FIG. 2. Referring to FIG. 3, upon starting of synchronization of base stations (step 30), an empty packet is used for setting up a call (step 31). Measurement of the average value of data quantity is repeated for a predetermined frequency (step 32). Here, when the data quantity is insufficient, the measurement of its average value continues. When the measured average value of the data quantity becomes sufficient, 20 msce slewable data is inserted (step 33). Upon completion of the insertion of slewable data, an offset value is compensated during the maintenance of the call (step 34). It is judged if the compensation is required in case of soft hand-over, and if it is judged to be required, the offset value is compensated during the maintenance of the call and if not, the process is finished.

As described above, the present invention uses paths for CDMA packet routines partly using functions of H.110 in the compact PCI standard bus, extracts clocks from networks without using a GPS and composes a reference clock of a base station controller using the extracted clocks to use it as a reference frequency in CDMA. In addition, the invention consolidates system maintenance functions to make the entire system smaller and simpler. Furthermore, in case where additional functions are required, only slots for realizing the functions are allocated, such that if becomes simplified in adding functions.

Although specific embodiments including the preferred embodiment have been illustrated and described, it will be obvious to those skilled in the art that various modifications may be made without departing from the spirit and scope of the present invention, which is intended to be limited solely by the appended claims

What is claimed is:

1. A system for realizing a base station controller in a compact PCI, in a mobile communication system including a plurality of BTSs, comprising:
a compact base station controller main processor block (CMPB) which includes a compact base station controller main processor assembly (CMPA) and a rear processor interface assembly (RPIA), for managing call processing in base stations and compact base station controllers and controlling the system;
a mobile station controller interface block (MIB) which is interfaced with the CMPB through a compact PCI and includes a mobile station controller vocoder interface and switching assembly (MVSA) and a rear mobile station controller interface assembly (RMIA) to provide an interface function and generate a reference clock;
a BTS interface block (BIB) which is connected to the BTSs and includes a base station controller vocoder interface and a router assembly (BVRA) and a rear base station controller interface assembly (RBIA) to route control data to the CMPB;
a transcoder and selector bank (TSB) which is connected to the BIB and includes a compact base station controller vocoder operation assembly (CVOA), a vocoder extension buffer assembly (VERA) and a rear vocoder extension interface assembly (RVIA) to perform vocoding and selecting functions.
a back plane for providing a compact PCI bus, H.110 and I/O bus to the CMPB; and
a system interface for performing interfacing among mobile station controllers, BTSs and compact base station controllers.

2. The system as claimed in claim 1, wherein the CMPA as a main processor of the compact base station controllers takes charge of management of call resources in the base stations and the compact base station controllers, operator interface, processing and managing failures/alarms, status management, system diagnostics management, processing base station controller calls, system form management, system loading and processing statistics.

3. The system as claimed in claim 1, wherein the RPIA supports an Ethernet port for executing operation and maintenance of one to three compact base station controllers.

4. The system as claimed in claim 1, wherein the MVSA manages mobile station controller trunks connected to the mobile station controllers and executes an IS-634 (A) interface, vocoder switching, an IWF interface and generation of a reference clock, the MVSA being interfaced with the CMPA using the compact PCI bus.

5. The system as claimed in claim 1, wherein the RMIA provides an E1/T1 trunk node for interfacing with the mobile station controllers.

6. The system as claimed in claim 1, wherein the BVRA manages BTS trunks connected to the BTSs and routes all control data transmitted to the CMPA.

7. The system as claimed in claim 1, wherein the RBIA provides an E1/T1 fractional E1 interface, extended compact base station controller HDSL packet data interface, and H.110 relay link interface with the BTSs.

8. The system as claimed in claim 1, wherein the system interface corresponds to channeled E1/T1 that is the interface between the mobile station controllers and the compact base station controllers, IS-634(A), E1/T1 fractional E1.IPC that is the interface between the BTSs and compact base station controllers, RS-422. IPC that is GW interface with the compact base station controllers, TCP/IP that is Ethernet between the compact base station controllers and base station operation system interface, H.110 that is the interface between a main shelf and a extension shelf, a compact PCI that is the interface between the main processor router and a switch, and H.110 that is the interface between a vocoder router and the switch.
